(19) United States
(12) Patent Application Publication
(10) Pub. No.: US 2004/0050104 A1
(43) Pub. Date: Mar. 18, 2004

(54) Forming information transfer lens array

(75) Inventors: Syamal K. Ghosh, Rochester, NY (US); Donn B. Carlton, Hamlin, NY (US); Darryl E. Miller, Honeoye Falls, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/246,556

(22) Filed: Sep. 18, 2002

(51) Int. Cl. C03C 27/00

(52) U.S. Cl. 65/36; 65/37; 264/1.32; 65/55

(57) ABSTRACT

A method of forming an array of optical elements for use in transmitting information includes using glass compression molding to form a plurality of discrete microlens element using a glass compression molding technique; placing each discrete microlens element in a mold cavity and aligning each microlens element in a predetermined location arranged in the form of a linear or two dimensional array; and molding by injection thermo-setting material into the cavity around each microlens element and cooling such thermo-setting material to form an integral array of optical elements that are retained in their respective locations.

### CROSS REFERENCE TO RELATED APPLICATION

Reference is made to commonly assigned U.S. patent application Ser. No. 10/036,722 filed Dec. 21, 2001 entitled “Method of Forming Precision Glass Microlens arrays and a Microlens Array Formed Therewith” by Miller et al; the disclosure of which is incorporated herein.

### FIELD OF THE INVENTION

The present invention relates, in general, to a method of forming optical lens arrays for transmitting information. More particularly, this invention relates to positioning discrete lens elements in a mold cavity and injection molding into an optical lens array.

### BACKGROUND OF THE INVENTION

Microlens arrays provide optical versatility in a miniature package for communications, display and image applications. Traditionally, a microlens is defined as a lens with a diameter less than one millimeter. From the practical point of view, lenses having diameter as large as five millimeter are also considered microlenses. For most of the applications, microlenses formed on the ends of optical fibers are employed to couple light from sources such as laser diodes to the fiber.

The use of microlenses in the form of arrays stems from the demand from the end users to work with information in parallel. The technologies of the semiconductor industry including micro electromechanical system (MEMS) lend themselves to the formation of arrays.

Microlenses can comprise diffractive or refractive functions, or the combinations of the two for athermal or achromatic elements. In fact, the benefits of refractive lenses, including achromatism efficiency and high numerical apertures, make them the most attractive for communication applications.

As individual elements, microlenses can have a wide range of parameters. Diameters can range from few microns to few millimeters. Their focal ratios, that is, the ratio of focal length to lens diameter, can range from f/0.8 to infinity. The optical surface can be either spherical or aspherical. Microlenses can be made from a variety of materials such as plastics, glasses and exotic materials like gallium phosphide.

Design issues for discrete microlenses and microlens arrays are very similar to those of conventional large lenses, so the rules of micro-optics still apply. Since the apertures of microlenses are so small, diffraction effects are more dominant than refraction effects. The most common fabrication techniques for microlens arrays include direct etching of the lens profile using photolithographic masks or contact masks, diffusing materials with different refractive indices into a substrate, swelling defined areas of a substrate, and forming and solidifying drops of liquid having desirable refractive index on a surface. Manufacturing specifications and tolerances for arrays are governed by the specific application and defined by the end user accordingly. For example, the typical focal length variation across an array comprising 0.1 mm to 1.0 mm diameter microlenses for communication use is 1 to 2 percent; cumulative pitch tolerance from one microlens to another must be less than 1 μm; optical surfaces are specified as plano/convex asphere; surface figure requirement is better than λ/8 at 632 nm; and center thickness tolerance of the array must not exceed 2 μm. The stringent specification for the microlens arrays for telecommunication application makes it necessary to synchronize a web of manufacturing technologies to attain the final goals. The manufacturing process can be broadly divided into three basic steps. They are originating the shape of the lens, creating a master and finally forming the lens profile on the surface of the selected optical material. The origination of the shape generally comprises photolithography technology to create a mask for reactive ion etching. Another commonly used manufacturing technique is to reflow a photoresist. This method comprises coating a substrate with a selected photoresist, exposing it to UV radiation through a mask or alternatively subject the photoresist to gray scale laser exposure. Upon heating the substrate, the exposed photoresist melts and surface tension pulls the material in the form of convex lenses. The depth of the photoresist determines the focal length of the lens.

Ion exchange is another method, which has been used for some time to manufacture microlenses. Ions are diffused into a glass rod to give a radial refractive index distribution that guides the light and that forms a focus. The index of refraction is highest in the center of the lens and decreases quadratically as a function of radial distance from the central axis. Microlenses made using this ion exchange technology are widely used to collimate light from fibers as for example in telecommunications. As applications warrant larger and larger arrays of channels, users are moving away from discrete microlenses towards microlens arrays.

Depending on the application, microlens materials may vary. For high volume applications using visible light, it is desirable to mass produce plastic optics using injection molding process. One advantage of injection molding is that high-resolution molding technique can mold the optical element as part of the system casing. This method is very cost-effective because the labor associated with alignment and assembly is eliminated. The optimal transmission wavelength for telecommunication is in the far infra-red wavelength, which is around between 1300 and 1550 nm. Therefore, the materials that work in this wavelength region are becoming more important. The two most common materials are fused silica and silicon, both of which have advantages and disadvantages as well for this application. Other optical quality materials are being tested and considered.

As mentioned earlier, the applications for microlenses are very broad. The primary use of microlenses in telecommunication is to match light from free space into fibers and to collimate light coming out of fibers. The microlens will require a numerical aperture that matches the fiber and diameter around 1 mm so that the diameter matches the free space beam. The microlenses are used in individual channels, although they are normally arranged in arrays of channels in 1×8, 1×12, 10×10 or even higher configurations. Some of the larger free-space devices are now using more than 1000 channels.

Manufacturing process for the production of glass microlens arrays generally involves reactive ion etching (RIE) of fused silica. RIE of fused silica is a relatively standard technology. But, fabrication of microlens arrays having the stringent specifications dictated by the telecommunication industry is by no means an easy or routine task. It is very difficult to meet all the requirements of microlens arrays using this technology. This technology also involves many steps before the final product is produced and consequently the yield is very poor and the products are not cost competitive.

Compression molding of optical quality glass to form microlenses is also well known. This method comprises compressing optical element preforms, generally known as gobs in the art, at high temperatures to form glass lens element. U.S. Pat. No. 3,833,347 to Angle et al, U.S. Pat. Nos. 4,139,677 and 4,168,961 to Blair et al, U.S. Pat. No. 4,797,144 to DeMeritt et al, and U.S. Pat. Nos. 4,883,528 and 4,897,101 and 4,929,265 to Carpenter et al described the basic process and apparatus for precision glass molding of optical elements. These patents disclose a variety of suitable materials for construction of mold surfaces used to form the optical surfaces in the molded glass optical elements. In the compression molding process described in the above patents a gob is inserted into a mold cavity. The molds reside within an oxygen-free chamber during the molding process. The gob is generally placed on the lower mold and heated above the glass transition temperature (Tg) and near the glass softening point so that the viscosity of the glass is within 10⁶ and 10⁹ poise. The upper mold is then brought in contact with the gob and pressure is applied to conform to the shape of the mold cavity. The molds and the molded lens are then allowed to cool well below Tg and the pressure on the molds are relieved and the lens is removed.

### SUMMARY OF THE INVENTION

It is, therefore, an object of the present invention to provide a microlens array with accurately located lens element.

It is another object of the present invention to provide a method of aligning the discrete microlens elements in a mold cavity of an injection molding machine and permanently retaining these elements in their respective positions.

Still another object of the present invention is to provide a method of locating each microlens element in a linear or two dimensional array inside a mold cavity and injecting thermo-setting material around each lens element to permanently secure those microlens elements as an integral part of the injection molded lens array.

These and other objects are achieved in a method of forming an array of optical elements for use in transmitting information comprising the steps of:

(a) using glass compression molding to form a plurality of discrete microlens element using a glass compression molding technique;

(b) placing each discrete microlens element in a mold cavity and aligning each microlens element in a predetermined location arranged in the form of a linear or two dimensional array; and

(c) molding by injection thermo-setting material into the cavity around each microlens element and cooling such thermo-setting material to form an integral array of optical elements that are retained in their respective locations.

The present invention has numerous advantages over prior art.

(a) precision location of the microlens arrays is primarily determined by the precision of the micro-injection molding method;

(b) precision discrete lens element can be produced cost-effectively;

(c) injection molding process is done at relatively lower temperature than compression molding. Therefore, closely matching coefficient of thermal expansion of injection molded ceramic-polymer composites or glass-polymer composites to that of the glass lens element is not that critical;

(d) location and orientation of each lens element can be adjusted very precisely prior to the micro-injection molding step; and

(e) microlens arrays having lens diameter less than 1 mm can be produced.

### BRIEF DESCRIPTION OF THE DRAWINGS

FIG. 1 depicts a side view schematic of a prior art compression molding apparatus for forming aspheric convex optical features on a ball preform and machining it to form a discrete microlens;

FIG. 2 depicts a partial cross sectional view inside a mold prior to micro-injection molding the array; and

FIG. 3 depicts a partial cross-sectional view of the micro-injection molded microlens array.

### DETAILED DESCRIPTION OF THE INVENTION

With regard to compression molding glass optical element as practiced in the prior art, it is well known that an optically finished glass preform surface must be pressed between the upper and lower mold halves of a mold arrangement.

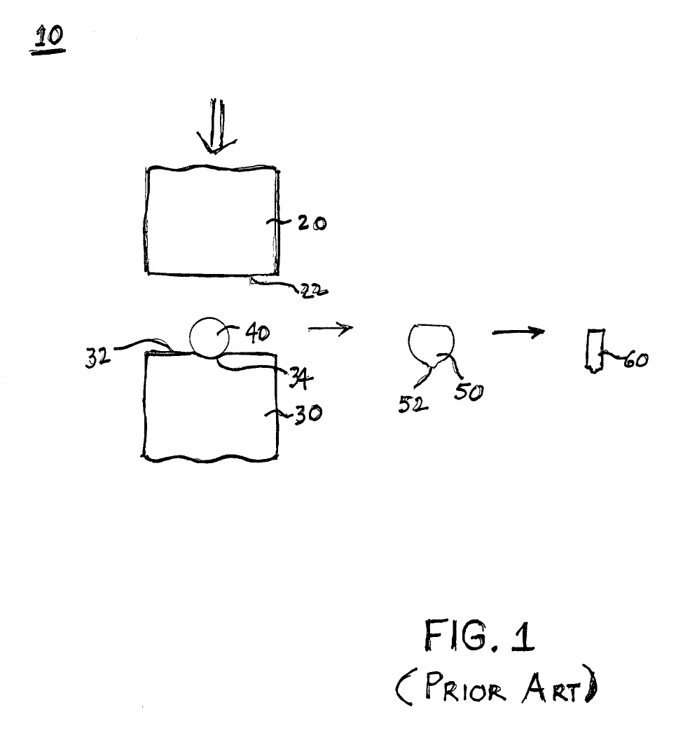

A preferred glass compression molding technique for practicing this invention is described below. A selected glass preform is placed between the mold halves. The mold halves are heated until the temperature goes at least above glass transition temperature, Tg, or preferably near the glass softening temperature. The preform is then compressed until the mold is closed, and cooled thereafter to a temperature below Tg or preferably below the annealing point of the glass and removed from the mold. Blair et al described in U.S. Pat. No. 4,139,677 details of compression molding process to form glass lens elements wherein molds were used having mold surfaces formed of silicon carbide or silicon nitride. Referring to FIG. 1, there is shown a glass compression molding arrangement 10 from the prior art wherein a first mold half 20 (upper) and a second mold half 30 (lower) compress a spherical glass preform 40 placed therebetween. Molding surface 22 of the upper mold half 20 has a plano surface and the molding surface 32 of the lower mold half 30 has a concave concave mold surface 34 so that the compression molded microlens 50 has a convex surface 52. It is sometimes desirable to add aspheric feature to the concave mold surface 34 so that the molded microlens 50 replicates the aspheric feature on to the convex surface 52. The outer periphery of the microlens 50 is then ground to form a discrete discrete microlens 60. Such molded and ground discrete microlens 60 typically has accurate and repeatable surface replication features relative to the features in the mold.

In the present invention, molds are fabricated of silicon carbide wherein molding surface 32 is formed by machining using conventional tools. If the geometry of the concave mold surface 34 is complex and the mold cavity diameter is well below 1 mm, it may not be possible to machine those features using conventional grinding and polishing process. MEMS or RIE methods are used then to form the concave mold surface 34 of fused silica and a release coating, such as hard carbon or silicon carbide or both are applied so that the heat softened glass preform 40 and the compression molded glass microlens 50 do not adhere to the mold surface 32.

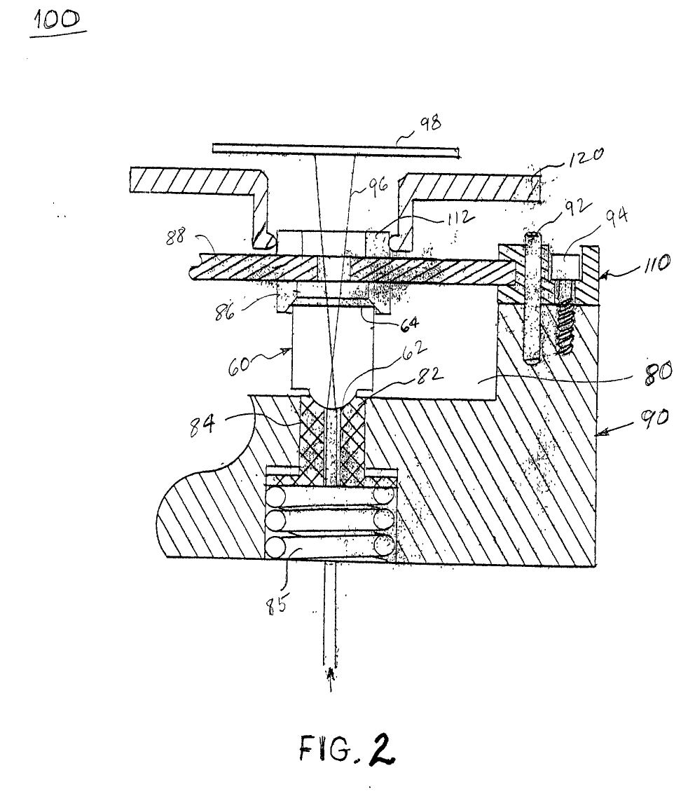

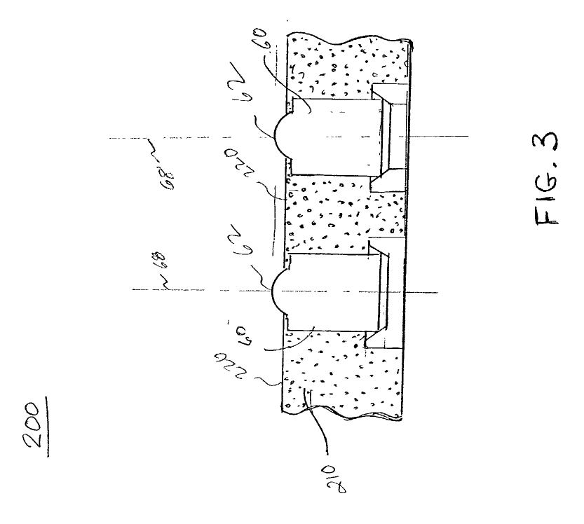

Referring to FIG. 2, there is shown a partial cross-sectional view of a mold arrangement 100 prior to injection molding of the microlens arrays. Each discrete microlens 60 formed by compression molding as described hereinbefore, is placed inside a mold cavity 80 including a first mold half 90 and a second mold half 110, aligned optically and held temporarily secured in their respective positions until the injection-molding process is completed. The preferred commercially available glasses to form discrete microlens for telecommunication application are Schott SF-57 and Hoya TaC-4 having CTE of 9.7×10⁻⁶/° C. and 6.7×10⁻⁶/° C., respectively. The compression molded convex glass surface 62 of the discrete microlens 60 is placed on the concave surface of the positioner 84, which rests on a spring 85 and the piano glass surface 64 of the discrete microlens 60 is held by an alignment ring 86, which is made from a ferromagnetic material like steel. The spring 85 is attached to the positioner 84 to provide a cushion effect while handling the glass discrete microlens 60 to prevent any chipping or breaking. After placing all the microlenses in the form of a predefined linear or two-dimensional array inside the mold cavity 80 and securing them properly, a cover plate 88 is placed on an alignment ring 86 which is attached firmly to the second mold half 110. Prior to injection molding, each discrete microlens 60 after being placed in the mold cavity 80 is aligned in a predetermined location arranged in the form of a linear or two dimensional array. The cover plate 88 must be made from non-magnetic material such as aluminum, titanium, ceramic or glass. The second mold half 110 is provided with a set of guide pin 92 which aid in locating and properly clamping the first mold half and second mold half 90 and 110 respectively, together and fasten thereafter with a set of bolt 94. Immediately after placing the second mold half 110 onto the first mold half 90 each discrete microlens 60 is aligned optically with a laser beam 96 against a target 98 with the help of a magnet 112 attached to a x-y micro-positioner 120. After all the microlenses for a given array are aligned, the fastening bolts are tightened and the mold assembly 100 is placed inside a micro-injection molding machine (not shown). Each discrete microlens 60 along with the corresponding alignment ring 86 are embedded by a specially formulated composite 210 (see FIG. 3) of thermo-setting material including a mixture of polymer and ceramic or a mixture of polymer and low expansion glass or a mixture of polymer, ceramic and low expansion glass thereof, by the process of micro-injection molding

Referring to FIG. 3, there is shown a partial cross-sectional view of a micro-injection molded microlens array 200. Each discrete microlens 60 is embedded by the composite 210 of thermo-setting material. Polymers used in the composite 210 for the micro-injection molding process are selected from polyethylene, cellulose acetate, polystyrene, polycarbonate and ABS. Ceramic filler used for the composite 210 is selected from ceramics having low coefficient of thermal expansion (CTE), such as silicon carbide (4.4×10⁻⁶/° C.) and silicon nitride (3.2×10⁻⁶/° C.). Similarly, glass frit used as a filler must have low CTE to match that of the glass of the discrete microlens 60. As for example, Coming 7913 glass (96% silica+Vycor®) has very low CTE (0.75×10⁻⁶/° C.). Micro-injection molding of composite 210 is done at temperatures in the range of 175 to 220° C., which is lower than the glass compression molding temperatures of 600 to 750° C. Therefore, structural defects arising from the CTE mismatch between the discrete microlens 60 glass and the composite 210 is minimized.

Referring to FIG. 3 again, the convex glass surface 62 of the microlens array 200 protrudes out of the molded composite surface 220. Since each discrete microlens 60 is aligned optically prior to micro-injection molding, the optical axes of all the microlenses in an array are aligned therewith and the axes are parallel to each other.

This invention is particularly suitable for production of microlens arrays having an aspheric surface profile. Furthermore, this method is particularly suitable for microlens arrays having lens diameter less than 1 mm and the spacing between the neighboring lenses is from 0.5 to 2.0 mm.

From the foregoing it will be seen that this invention is one well adapted to attain all of the ends and objects hereinabove set forth together with other advantages which are apparent and which are inherent to the process.

It will be understood that certain features and subcombinations are of utility and may be employed with reference to other features and subcombinations. This is contemplated by, and is within the scope of the claims.

As many possible embodiments may be made of the invention without departing from the scope thereof, it is to be understood that all matter herein set forth and shown in the accompanying drawings is to be interpreted as illustrative and not in a limiting sense.

The invention has been described in detail with particular reference to certain preferred embodiments thereof, but it will be understood that variations and modifications can be effected within the spirit and scope of the invention.

PARTS LIST

| | |
|---|---|
| 10 | compression molding arrangement |
| 20 | first mold half |
| 22 | molding surface |
| 30 | 30 second mold half |
| 32 | molding surface |
| 34 | concave mold surface |
| 40 | glass preform |
| 50 | microlens |
| 52 | convex aspheric surface |
| 60 | discrete microlens |
| 64 | plano glass surface |
| 62 | convex glass surface |
| 80 | mold cavity |
| 84 | positioner |
| 85 | spring |
| 86 | alignment ring |
| 88 | cover plate |
| 90 | first mold half |
| 91 | guide pin |
| 94 | bolt |
| 96 | laser beam |
| 98 | target |
| 100 | mold arrangement |
| 110 | second mold half |
| 112 | magnet |
| 120 | x-y micro-positioner |
| 200 | microlens array |
| 210 | composite |
| 220 | composite surface |

What is claimed is:

1. A method of forming an array of optical elements for use in transmitting information comprising the steps of:
(a) using glass compression molding to form a plurality of discrete microlens element using a glass compression molding technique;
(b) placing each discrete microlens element in a mold cavity and aligning each microlens element in a predetermined location arranged in the form of a linear or two dimensional array; and
(c) molding by injecting thermo-setting material into the cavity around each microlens element and cooling such thermo-setting material to form an integral array of optical elements that are retained in their respective locations.

2. A method of forming an array of optical elements for use in transmitting information comprising the steps of:
(a) forming a plurality of discrete microlens element using a glass compression molding technique;
(b) placing each discrete microlens element in a mold cavity and aligning each microlens element in a predetermined location arranged in the form of a linear or two dimensional array; and
(c) heating thermo-setting material, injecting the heated thermo-setting material into the cavity, while applying pressure to such heated thermo-setting material to form such microlens array.

3. The method of claim 2 wherein the thermo-setting material includes a polymer selected from the group consisting of polyethylene, cellulose acetate, polystyrene or polycarbonate and a mixture thereof.

4. The method of claim 2 wherein the thermo-setting material includes a ceramic having low coefficient of thermal expansion consisting of silicon nitride or silicon carbide or a mixture thereof.

5. The method of claim 2 wherein thermo-setting material includes a glass frit having low coefficient of thermal expansion consisting of glass.

6. The method of claim 4 wherein the coefficient of thermal expansion of the ceramic ranges from 3.2×10⁻⁶/⁰C to 4.4×10⁻⁶/⁰C.

7. A product made in accordance with claim 1.
